(19) United States
(12) Patent Application Publication
(10) Pub. No.: US 2018/0253559 A1
(43) Pub. Date: Sep. 6, 2018

(54) SECURED LOSSLESS DATA COMPRESSION USING ENCRYPTED HEADERS

(71) Applicant: INTEL CORPORATION, SANTA CLARA, CA (US)

(72) Inventors: SUDHIR K. SATPATHY, HILLSBORO, OR (US); VIKRAM B. SURESH, PORTLAND, OR (US); SANU K. MATHEW, HILLSBORO, OR (US)

(73) Assignee: INTEL CORPORATION, SANTA CLARA, CA (US)

(21) Appl. No.: 15/446,995

(22) Filed: Mar. 1, 2017

(51) Int. Cl. G06F 21/60; H04L 9/06; G06F 3/06

(52) U.S. Cl. CPC G06F 21/602; H04L 9/0618; G06F 3/0608; G06F 3/0683; G06F 3/0619; G06F 3/0647; G06F 3/0661; G06F 3/0613

(57) ABSTRACT

Various embodiments are generally directed to providing a unified data compression-encryption. In particular, compressed data blocks are secured by encrypting the metadata of the compressed data blocks without the need for encrypting the entire compressed data payload. Selected portions of the payload may be encrypted as desired and identified by using tags that indicate beginning and end of encryption boundaries. In addition, authenticated encryption enables integrity checking at the end of decryption-decompression procedure.

### TECHNICAL FIELD

Embodiments described herein generally relate to data compression and encryption, and particularly relate to a unified data compression and encryption techniques for information processing systems.

### BACKGROUND

Content protection and data compression are two critical aspects in many information processing systems. The algorithmic complexity and performance-critical computations involved in these functions usually require the need for costly, specialized hardware to meet real time throughput requirement, as well as present significant challenges in managing power consumption and data throughput. Therefore, there is a need for improving overall throughput while simultaneously eliminating the need for costly, specialized hardware.

### BRIEF DESCRIPTION OF THE DRAWINGS

FIG. 1a illustrates block diagrams of three data block formats according to embodiments.

FIG. 1b illustrates a block diagram of a compressed data block of FIG. 1a in greater detail.

FIG. 2a illustrates a block diagram of a compressed data block having an encrypted header according to an embodiment

FIG. 2b illustrates a block diagram of a compressed data block having an encrypted header and an encrypted payload portion according to an embodiment

FIG. 3 illustrates a block diagram of a compressed data block having an encrypted header, an encrypted payload portion, and an authentication tag according to an embodiment

FIG. 4 illustrates a logic flow to provide a compression-encryption of a data block according to an embodiment.

FIG. 5 illustrates a logic flow to provide a decompression-decryption of a data block according to an embodiment.

FIG. 6 illustrates a logic flow to provide a compression-encryption of a data block according to an embodiment.

FIG. 7 illustrates a logic flow to provide a decompression-decryption of a data block according to an embodiment.

FIG. 8 illustrates a block diagram of an embodiment of computer-readable storage medium.

FIG. 9 illustrates a block diagram of an embodiment of a computing architecture.

FIG. 10 illustrates a block diagram of an embodiment of a communications architecture.

FIG. 11 illustrates a block diagram of an embodiment of a communications device.

FIG. 12 illustrates a block diagram of an embodiment of a broadband wireless access system.

### DETAILED DESCRIPTION

A compressed block can be arbitrarily long and may span gigabits of data. Securing such a compressed payload in a conventional manner would require encrypting the entire compressed block, which in turn requires not only specialized cipher accelerators, but also increases latency resulting in diminished data throughput Instead, the various embodiments disclosed herein provide an alternative security solution which exploits the dependency of the compressed data (payload) on its metadata for payload recovery.

Various embodiments are generally directed to providing a unified data compression-encryption technique, and directed more particularly to securing compressed data blocks in storage and transmission by selectively encrypting information associated with compressed data blocks, or portions of the compressed data blocks, without the need for encrypting the entire compressed data payload. In one embodiment, for example, techniques may selectively encrypt metadata for a compressed data block, thereby effectively protecting a compressed data payload associated with the encrypted metadata. Selective encryption of compressed data provides significant technical advantages, such as substantially improving overall data throughput, reducing or eliminating a need for expensive specialized hardware (e.g., cipher accelerators), providing efficient use of compute and communications resources, and other software and hardware improvements for an electronic device.

Information protection and data compression are increasingly becoming important in ecosystems of smart and connected devices where data is continuously created and shared across various computing platforms. Encryption and data-compression are important and directly impact user experience in a broad range of applications such as web traffic, index servers, input/output (I/O) assistance in file systems, in-memory database, media, etc. Usually these applications and/or computing platforms are constrained by severe area and power budgets. Therefore, addressing the bottlenecks in existing standards for these applications is of great interest, and there is significant advantage in providing a unified solution that co-optimizes these critical functions of encryption and data compression. The various embodiments disclosed herein leverage the entropy amplification properties of compression techniques to simplify the encryption step, thus enabling significant power and area savings. The various embodiments disclosed herein may be implemented as software and/or as hardware.

Various encryption schemes may be utilized to generate a secured compressed bitstream from raw data, such as block-cipher-based encryption schemes (e.g., Advanced Encryption Standard (AES)), and entropy-encoding-based compression schemes (e.g., DEFLATE), and so forth. Current solutions for encryption and data compression operate independently on a bitstream. The high latency and hardware cost for accelerating AES and DEFLATE, for example, result in significant power and performance bottlenecks limiting usage in battery-constrained and/or energy-constrained applications, e.g., Internet-of-Things (IoT) platforms. In response, the various embodiments disclosed herein provided a unified solution which utilizes metadata (e.g., dictionary, Huffman-trees, etc.) encryption in a compressed data stream to ensure a high level of security for the payload, thus significantly improving the overall data throughput while simultaneously eliminating the need for expensive specialized hardware, e.g., cipher accelerators. Using the various embodiments disclosed herein, compressed data streams can be secured, e.g., for storage and transfer, by protecting their metadata without the need for encrypting the entire payload. Furthermore, by adding two identifying tokens, selective encryption for critical portions of the payload is enabled to provide a higher degree of protection when desired.

Although the various embodiments disclosed herein are explained in the context of AES and DEFLATE techniques which are widely known, these techniques are purely exemplary, and other block ciphers and compression protocols may be utilized. Examples are not limited in this context.

An example embodiment provides payload compression which includes encrypting selected portions of the payload in a block with Huffman-encoded tags that indicate beginning and end of encryption boundaries. This enables selective adoption of a higher degree of security as desired in specific applications.

Another example embodiment provides authenticated encryption which enables integrity checking at the end of decryption-decompression procedure.

Compression techniques such as LZ77 and Huffman encoding reduce a data block's footprint by eliminating existing repetitions and correlations within the data block's bitstream. This results in a high entropy bitstream which exhibits a higher degree of randomness. The compressed stream is later recovered using a dictionary or Huffman-tree, for example. Encryption algorithms such as AES convert a correlated non-random bitstream into an almost random stream that is later recovered using an encryption key. This correspondence between the encryption key of an encryption algorithm (e.g., AES) and the dictionary or Huffman-tree of the compressed bitstream is utilized in the various embodiments to protect a compressed payload by protecting its metadata, e.g., dictionary or Huffman-tree of the compressed bitstream. In other words, the metadata appearing at the header of a compressed bitstream can be encrypted to secure the payload without explicitly encrypting the entire payload.

Because Huffman-encoded, compressed bitstreams are not byte-aligned, it is extremely challenging to identify the beginning of any specific token, which in turn makes it extremely challenging to selectively protect any specific group of tokens in a compressed stream. By including two special tokens in the Huffman tree, e.g., beginning-of-encryption (BOE) token and end-of-encryption (EOE) token, this example embodiment enables isolation and identification of any desired section in a compressed stream for encryption. Furthermore, because these BOE and EOE tokens are Huffman-encoded and encrypted, the beginning and end of these protected sections can't be determined by an unauthorized party without access to the encryption key.

In addition, content can be protected using a stream cipher mode of operation like cipher block chaining (CBC), and an authentication tag can be appended to the end of the compressed and encrypted payload to enable integrity checking.

Various embodiments are described in the context of data blocks formatted in accordance with the DEFLATE format (Deutsch, P., “DEFLATE Compressed Data Format Specification version 1.3”, RFC 1951, DOI 10.17487/RFC1951, May 1996),. It should be evident, however, that other compression protocols may be utilized in the various embodiments.

DEFLATE is a lossless data compression algorithm that uses a combination of LZ77 compression algorithm and Huffman coding. LZ77 compression involves replacing a sequence of data characters with a duplicate sequence of data characters found within the previous 32 KB of uncompressed data (32 KB “sliding window”). When a given sequence of data characters to be compressed is identical to a previous sequence within the 32 KB sliding window, the given sequence of data characters is replaced by a pair of numbers representing a back-reference to the previous sequence, e.g., a coded “length” number (257-285) representing the number of bytes (3-258 bytes) in the duplicate sequence, and a coded “distance” number (0-29) representing how far back (1-32768 bytes) into the sliding window the duplicate sequence starts.

The second part of compression in DEFLATE involves Huffman coding, which is a prefix coding scheme. Prefix coding represents symbols from a known alphabet by bit sequences (codes), one code for each symbol, in a manner such that (i) different symbols may be represented by bit sequences of different lengths, and (ii) a parser can always parse an encoded string unambiguously symbol-by-symbol.

A prefix code may be defined in terms of a binary tree in which (i) the two edges descending from each non-leaf node are labeled 0 and 1, and (ii) the leaf nodes correspond one-for-one with (e.g., are labeled with) the symbols of the alphabet. As a result, the code for a given symbol is the sequence of 0's and 1's on the edges leading from the root to the leaf labeled with the given symbol. A parser can decode the next symbol from an encoded input stream by walking down the tree from the root, at each step choosing the edge corresponding to the next input bit Given an alphabet with known symbol frequencies, the Huffman algorithm allows the construction of an optimal prefix code (one which represents strings with those symbol frequencies using the fewest bits of any possible prefix codes for that alphabet). The Huffman codes used for each alphabet in DEFLATE format have two additional rules: (i) all codes of a given bit length have lexicographically consecutive values, in the same order as the symbols they represent; and (ii) shorter codes lexicographically precede longer codes. Given these rules, the Huffman code for an alphabet may be defined just by giving the bit lengths (or code lengths) of the codes for each symbol of the alphabet in order.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, known structures and devices are shown in block diagram form in order to facilitate a description thereof. The intention is to provide a thorough description such that all modifications, equivalents, and alternatives within the scope of the claims are sufficiently described.

Additionally, reference may be made to variables, such as, “a”, “b”, “c”, which are used to denote components where more than one component may be implemented. It is important to note, that there need not necessarily be multiple components and further, where multiple components are implemented, they need not be identical. Instead, use of variables to reference components in the figures is done for convenience and clarity of presentation.

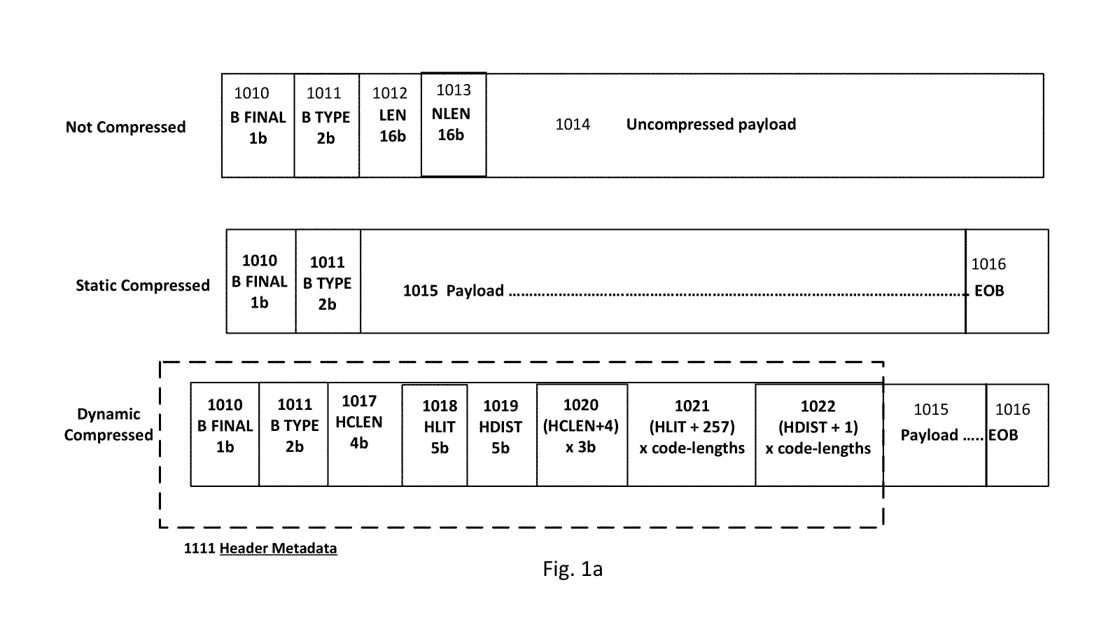

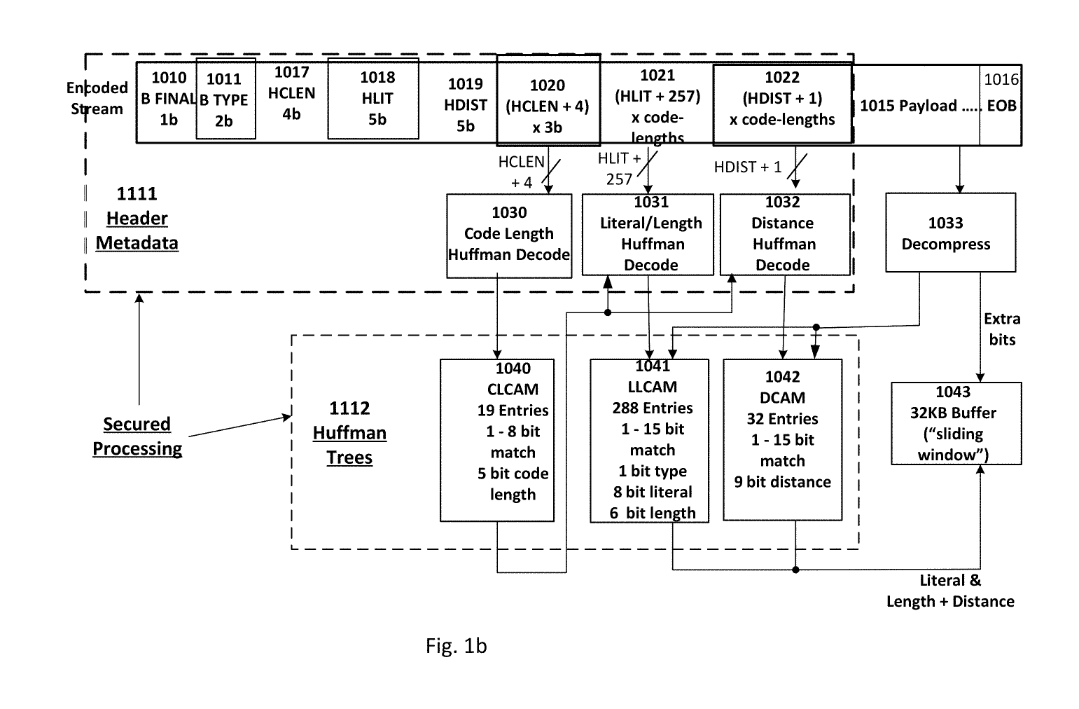

Fig. la shows the three possible data block formats in accordance with DEFLATE Compressed Data Format Specification version 1.3, e.g., uncompressed data block format (top of FIG. 1a), format of data block compressed with static (fixed) Huffman codes (middle of FIG. 1a), and format of data block compressed with dynamic Huffman codes (bottom of FIG. 1a). In each of the shown data block formats, the first bit is BFINAL field 1010 indicating whether the data block is the last block of the data set, and the next two bits are BTYPE field 1011 indicating how the data block is compressed (00-no compression; 01-compressed with fixed Huffman codes; 10-compressed with dynamic Huffman codes).

For the uncompressed data block format shown at the top of FIG. 1a, B FINAL field 1010 and BTYPE field 1011 are followed by LEN field 1012, NLEN field 1013 and the actual uncompressed data (payload) field 1014. LEN field 1012 indicates the number of data bytes in the uncompressed data, and NLEN field 1013 is the one's complement of the number in LEN field 1012.

For the two compressed data block formats shown in FIG. 1a (static compressed and dynamic compressed), each compressed data block is defined by two parts: (i) Huffman code trees that describe the coded representation of the compressed data (payload), and (ii) the compressed data (payload). The compressed data consists of a series of elements of two types: (i) literal bytes (0-255 bytes of data strings that have not been detected as duplicated within the previous 32K input bytes or “sliding window”), and (ii) back-reference pointers for duplicated strings, each pointer being represented as a coded pair <length, distance (backward)>, in which the represented length may be 3 to 258 bytes, and the represented distance may be 1 to 32,768 bytes. Each type of value (literals, lengths, and distances) in the compressed data is represented using a Huffman code, one code tree being used for literals and lengths, and a second code tree being used for distances.

The literal and length code alphabets are merged into a single alphabet (0-285) in which codes 0-255 represent literal bytes, the code 256 indicates end-of-block (EOB), and codes 257-285 represent length codes (possibly in conjunction with extra bits following the associated length codes) as shown below in Table 1:

TABLE 1

| Code | Extra Bits | Length(s) | Code | Extra Bits | Lengths | Code | Extra Bits | Length(s) |
|---|---|---|---|---|---|---|---|---|
| 257 | 0 | 3 | 267 | 1 | 15, 16 | 277 | 4 | 67-82 |
| 258 | 0 | 4 | 268 | 1 | 17, 18 | 278 | 4 | 83-98 |
| 259 | 0 | 5 | 269 | 2 | 19-22 | 279 | 4 | 99-114 |
| 260 | 0 | 6 | 270 | 2 | 23-26 | 280 | 4 | 115-130 |
| 261 | 0 | 7 | 271 | 2 | 27-30 | 281 | 5 | 131-162 |
| 262 | 0 | 8 | 272 | 2 | 31-34 | 282 | 5 | 163-194 |
| 263 | 0 | 9 | 273 | 3 | 35-42 | 283 | 5 | 195-226 |
| 264 | 0 | 10 | 274 | 3 | 43-50 | 284 | 5 | 227-257 |
| 265 | 1 | 11, 12 | 275 | 3 | 51-58 | 285 | 0 | 258 |
| 266 | 1 | 13, 14 | 276 | 3 | 59-66 | | | |

The distance codes (along with possible extra bits following the distance codes) are shown below in Table 2:

TABLE 2

| Code | Extra Bits | Dist | Code | Extra Bits | Dist | Code | Extra Bits | Distance |
|---|---|---|---|---|---|---|---|---|
| 0 | 0 | 1 | 10 | 4 | 33-48 | 20 | 9 | 1025-1536 |
| 1 | 0 | 2 | 11 | 4 | 49-64 | 21 | 9 | 1537-2048 |
| 2 | 0 | 3 | 12 | 5 | 65-96 | 22 | 10 | 2049-3072 |
| 3 | 0 | 4 | 13 | 5 | 97-128 | 23 | 10 | 3073-4096 |
| 4 | 1 | 5, 6 | 14 | 6 | 129-192 | 24 | 11 | 4097-6144 |
| 5 | 1 | 7, 8 | 15 | 6 | 193-256 | 25 | 11 | 6145-8192 |
| 6 | 2 | 9-12 | 16 | 7 | 257-384 | 26 | 12 | 8193-12288 |
| 7 | 2 | 13-16 | 17 | 7 | 385-512 | 27 | 12 | 12289-16384 |
| 8 | 3 | 17-24 | 18 | 8 | 513-768 | 28 | 13 | 16385-24576 |
| 9 | 3 | 25-32 | 19 | 8 | 769-1024 | 29 | 13 | 24577-32768 |

It should be noted that distance codes 30 and 31 exist, but will not actually occur in the compressed data.

In the case of the static compressed data block format shown in the middle of FIG. 1a, the Huffman codes for the literal/length alphabet and the distance alphabet are fixed by the DEFLATE specification, and therefore the Huffman codes are not represented explicitly in the compressed data block. For the sake of added clarity, the Huffman code lengths for the literal/length alphabet are shown below in Table 3:

TABLE 3

| Lit./len. Value | Bits | Codes |
|---|---|---|
| 0-143 | 8 | 00110000 through |
| | | 10111111 |
| 144-255 | 9 | 110010000 through |
| | | 111111111 |
| 256-279 | 7 | 0000000 through |
| | | 0010111 |
| 280-287 | 8 | 11000000 through |
| | | 11000111 |

It should be noted that, according to DEFLATE specification, literal/length values 286 and 287 will never actually occur in the compressed data. However, the slots for literal/length values 286 and 287 are utilized in at least one embodiment described in further detail below.

In addition, in the static compressed data block format, distance codes 0-29 shown in Table 2 are represented by fixed-length 5-bit codes, with possible additional bits as shown in Table 2.

In summary, the following fields are provided in the static compressed data block format: BFINAL field 1010; BTYPE field 1011; compressed data (payload) field 1015; and end of block (EOB) field 1016.

In the case of the dynamic compressed data block format shown at the bottom of FIG. 1a, the Huffman codes for the literal/length alphabet and the distance alphabet are explicitly presented after the BFINAL field 1010 and the BTYPE field 1011, and before the compressed data (payload) field 1015. The Huffman code trees for the literal/length alphabet (0-285) and the distance alphabet (0-29) are each defined by a sequence of code lengths, and the code length sequences (list of up to 286 literal/length lengths and up to 30 distance lengths) themselves are compressed using Huffman codes and run-length encoding, e.g., a further Huffman code tree for the code length alphabet is provided. The code length alphabet is shown below in Table 4:

TABLE 4

0 - 15: Represent code lengths of 0 - 15

16: Copy the previous code length 3 - 6 times.

The next 2 bits indicate repeat length

(0 = 3, ... , 3 = 6)

Example: Codes 8, 16 (+2 bits 11),

16 (+2 bits 10) will expand to
12 code lengths of 8 (1 + 6 + 5)

17: Repeat a code length of 0 for 3 - 10 times.

(3 bits of length)

18: Repeat a code length of 0 for 11 - 138 times

(7 bits of length)

A code length of 0 indicates that the corresponding symbol in the literal/length or distance alphabet will not occur in the block, and should not participate in the Huffman code construction. If only one distance code is used, it is encoded using one bit, not zero bits; in this case there is a single code length of one, with one unused code. One distance code of zero bits means that there are no distance codes used at all (the data is all literals).

In summary, in the case of the dynamic compressed data block format shown at the bottom of FIG. 1a, the header metadata 1111 includes the BFINAL field 1010, BTYPE field 1011, and the following fields which define the Huffman code trees that describe the coded representation of the compressed data (payload): 4 bits of HCLEN field 1017 (number of code length codes minus 4); 5 bits of HLIT field 1018 (number of literal/length codes minus 257); 5 bits of HDIST field 1019 (number of distance codes minus 1); field 1020 ((HCLEN+4)×3 bits: code lengths for the code length alphabet shown in Table 4); field 1021 ((HLIT+257)×(code lengths for the literal/length alphabet, encoded using the code-length Huffman code)); field 1022 ((HDIST+1)×(code lengths for the distance alphabet, encoded using the code-length Huffman code)). The header metadata 1111 is followed by: i) the compressed data (payload) field 1015 containing the actual compressed data of the block, encoded using the literal/length and distance Huffman codes; and ii) end of block (EOB) field 1016 containing the EOB token represented by the literal/length symbol 256, encoded using the literal/length Huffman code.

The various embodiments are described in the context of a data block which is compressed according to the DEFLATE format using LZ77 algorithm and canonical Huffman prefix coding. As described above in connection with FIG. 1a, information defining the Huffman code trees (code-length alphabet tree, literal/length alphabet tree, and distance alphabet tree) that describe the coded representation of the compressed data (payload) is concatenated to the payload as metadata 1111. For every block of compressed data, the metadata is processed to recreate the original, uncompressed data. The end-of-block (EOB) field 1016 indicates the end of the compressed data (payload) and the beginning of metadata for the next block of compressed data.

During decompression, the metadata is processed to gather the code lengths (or “tokens”) for the code-length alphabet, the code lengths for the literal/length alphabet, and the code lengths for the distance alphabet As shown in FIG. 1b, field 1020 ((HCLEN+4)×3bits) is read (schematically represented by block 1030 in FIG. 1b) to determine the code lengths for the code-length alphabet shown in Table 4, in the following specified order: 16, 17, 18, 0, 8, 7, 9, 6, 10, 5, 11, 4, 12, 3, 13, 2, 14, 1, 15. Huffman codes for 16, 17, 18, 0, 8, 7, 9, 6, 10, 5, 11, 4, 12, 3, 13, 2, 14, 1, 15 are derived from the code-lengths, and the Huffman codes are then stored in a content-addressable memory (CAM), e.g., the code-length CAM (CLCAM) 1040.

In addition, as shown in FIG. 1b, fields 1021 ((HLIT+257)×code lengths) and 1022 ((HDIST+1)×code lengths) are read (schematically represented by blocks 1031 and 1032, respectively, in FIG. 1b) using the code-length Huffman code tree stored in CLCAM 1040 to determine the code lengths (or “tokens”) for the literal/length alphabet and the code lengths (or “tokens”) for the distance alphabet. The code lengths for the literal/length alphabet are stored as a literal/length Huffman code tree in a content-addressable memory (CAM), e.g., the literal/length CAM (LLCAM) 1041. The code lengths for the distance alphabet are stored as a distance Huffman code tree in a content-addressable memory (CAM), e.g., the distance CAM (DCAM) 1042. The Huffman code trees stored in CLCAM 1040, LLCAM 1041 and DCAM 1042 are uniquely generated for every block of compressed data.

The compressed data (payload) 1015 is decompressed (schematically represented by block 1033 in FIG. 1b) using the Huffman code trees stored in LLCAM 1041 and DCAM 1042, as well as any extra bits used in conjunction with the Huffman codes, with reference to a 32-kilobyte sliding window in buffer 1043, as shown in FIG. 1b.

A compressed block can be arbitrarily long and may span gigabits of data. Securing such a compressed payload in a conventional manner would require encrypting the entire compressed block, which in turn requires not only specialized cipher accelerators, but also increases latency resulting in diminished data throughput Instead, the various embodiments disclosed herein provide an alternative security solution which exploits the dependency of the compressed data (payload) on its metadata for payload recovery.

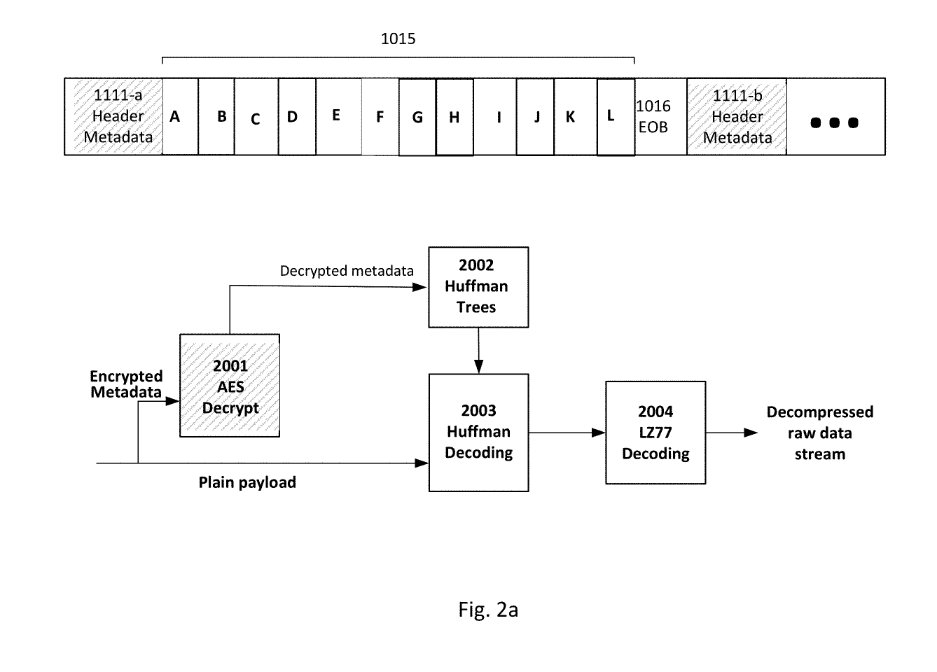

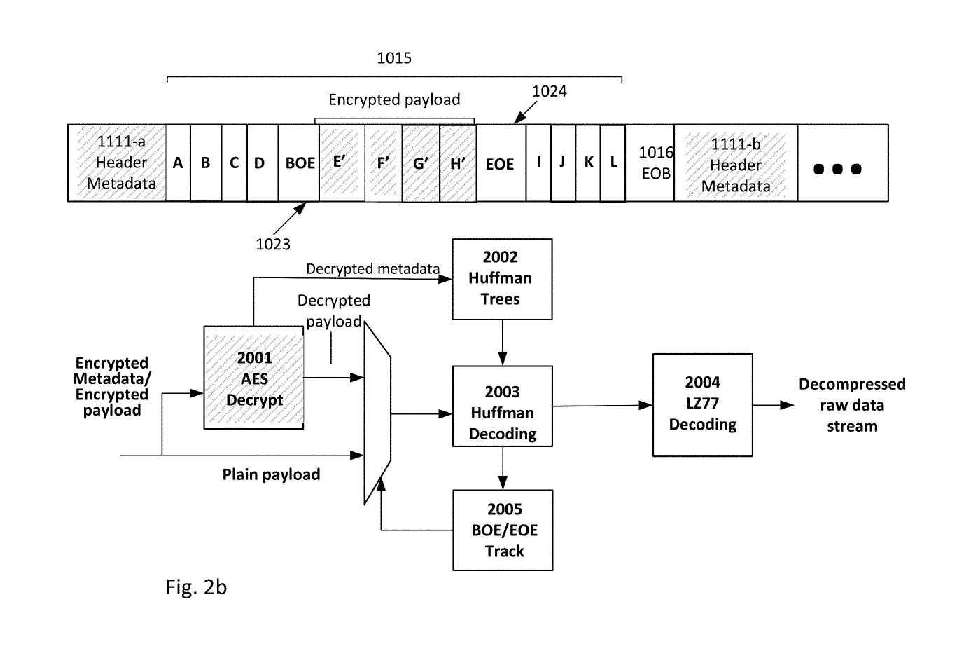

Shown in FIG. 2a is an embodiment in which only the header metadata of a data block compressed according to the DEFLATE format is encrypted. The compressed data block (shown at the top of FIG. 2a) includes: header metadata 1111-a representing Huffman code trees, which header metadata has been encrypted (e.g., using AES); the compressed payload 1015; and end-of-block (EOB) token 1016. Because the Huffman code trees represented in the header metadata function as a key for decoding (decompressing) the compressed payload 1015, securing the header metadata using a cipher standard (e.g., AES) renders unauthorized decoding of the compressed payload 1015 extremely challenging. As shown at the bottom portion FIG. 2a, during the decompression stage for generating the decompressed raw data stream from the compressed data block, the encrypted header metadata undergoes AES decryption (shown at block 2001), and the payload is decompressed using the Huffman code trees generated from the header metadata (shown at block 2002) by Huffman decoding (shown at block 2003) and LZ77 decoding (shown at block 2004) until the EOB token 1016 is read.

Shown in FIG. 2b is an embodiment in which a portion of the compressed payload 1015 is encrypted in addition to the header metadata 1111-a of a data block compressed according to the DEFLATE format The compressed data block (shown at the top of FIG. 2b) includes: header metadata 1111-a containing Huffman code trees, which header metadata has been encrypted (e.g., using AES); the compressed payload 1015; and end-of-block (EOB) token 1016. In this embodiment, the compressed payload 1015 includes a portion (designated by the shaded blocks E′, F′, G′ and H′) which has been encrypted (e.g., using AES). The encrypted portion of the payload 1015 is identified by two additional Huffman code tokens, e.g., a beginning-of-encryption (BOE) token 1023 and an end-of-encryption (EOE) token 1024, which tokens may be represented by literal/length values 286 and 287 of the DEFLATE format, for example.

As shown at the bottom portion FIG. 2b, during the decompression stage for generating the decompressed raw data stream from the compressed data block, the encrypted header metadata undergoes AES decryption (shown at block 2001), and the Huffman code trees (shown at block 2002) generated from the header metadata are used to decompress the payload by the Huffman decoding (shown at block 2003) and the LZ77 decoding (shown at block 2004). For the encrypted payload portion defined by the BOE token 1023 and EOE token 1024, the BOE and EOE tokens are tracked (block 2005) during decompression, such that the encrypted payload portion defined by the BOE and EOE is AES-decrypted (block 2001) and decoded using Huffman decoding (block 2003) and LZ77 decoding (block 2004).

By utilizing the BOE token 1023 and EOE token 1024, added security may be provided for critical information in a compressed data stream without the need to explicitly encrypt the entire payload, thereby also achieving improvement in data throughput. As an example, the addition of BOE and EOE tokens incurs a mere 0.6% area penalty without impacting compression and decompression performance for a compressed DEFLATE data stream constructed using approximately 300 tokens. In addition, although AES block cipher operates on 128 bits of data, tokens included in a compressed DEFLATE data stream can have any arbitrary alignment, which means a secured payload section can end in the middle of a token.

Although the embodiment shown in FIG. 2b depicts only one encrypted portion within the payload 1015, it should be readily apparent to one of ordinary skill in the art that multiple sections within a compressed payload can be selectively encrypted. In the case the encrypted sections exceed 128 bits, a stream cipher mode, e.g., AES Counter (CTR) mode or cipher block chaining (CBC) mode, can be used. At the receiver end, the stream cipher selectively decrypts the encrypted sections as indicated by the BOE and EOE tokens, and the decryption is halted for remaining sections of the payload that is not encrypted.

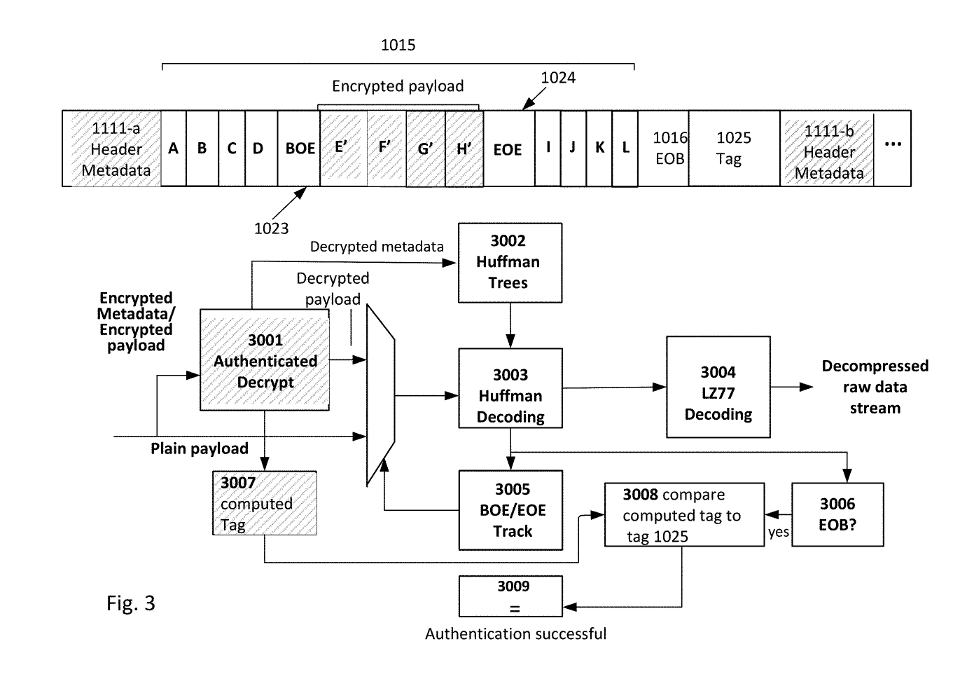

Shown in FIG. 3 is an embodiment in which a portion of the compressed payload 1015 is encrypted in addition to the header metadata 1111-a of a data block compressed according to the DEFLATE format, and an authentication tag 1025 is concatenated at the end of the payload after the EOB token 1016. The compressed data block (shown at the top of FIG. 3) includes: header metadata 1111-a containing Huffman code trees, which header metadata has been encrypted (e.g., using AES); the compressed payload 1015; end-of-block (EOB) token 1016; and authentication tag 1015. In this embodiment, the compressed payload 1015 includes a portion (designated by the shaded blocks E′, F′, G′ and H′) which has been encrypted (e.g., using AES). The encrypted portion of the payload 1015 is identified by two additional Huffman code tokens, e.g., a beginning-of-encryption (BOE) token 1023 and an end-of-encryption (EOE) token 1024, which tokens may be represented by literal/length values 286 and 287 of the DEFLATE format, for example.

The authentication tag 1025 can be concatenated by Galois/counter mode (GCM) using 128 bits, for example. During decompression, the receiver computes the tag while decrypting the payload and compares the computed tag with the tag 1025 that immediately follows EOB token 1016 for authentication, as shown in FIG. 3.

Galois/counter mode (GCM) combines the well-known counter mode of encryption with the Galois mode of authentication. In the counter mode of encryption, blocks are numbered sequentially, and then this block number is encrypted with a block cipher, e.g., AES. The encryption result is then XO Red with the plain text to produce a cipher text. Subsequently, the Galois function combines the cipher text with an authentication code in order to produce an authentication tag, which is used to authenticate the integrity of the data.

The authentication tag is constructed by feeding blocks of data into the GHASH function and encrypting the result. This GHASH function is defined by

GHASH(H,A,C)=Xₘ₊ₙ₊₁

where H is the Hash Key, a string of 128 zero bits encrypted using the block cipher, A is data which is only authenticated (not encrypted), C is the ciphertext, m is the number of 128 bit blocks in A, n is the number of 128 bit blocks in C (the final blocks of A and C need not be exactly 128 bits), and the variable Xᵢ for i=0, . . . m+n+1 is defined as

$${X}_{i} = \{ \begin{matrix}0 & for i = 0 \\ ( {X}_{i - 1} ⊕ {A}_{i} ) \cdot H & for i = 1 , … , m - 1 \\ ( {X}_{m - 1} ⊕ ( {A}_{m}^{*} \vert \vert {0}^{128 - v} ) ) \cdot H & for i = m \\ ( {X}_{i - 1} ⊕ {C}_{i - m} ) \cdot H & for i = m + 1 , … , m + n - 1 \\ ( {X}_{m + n - 1} ⊕ ( {C}_{n}^{*} \vert \vert {0}^{128 - u} ) ) \cdot H & for i = m + n \\ ( {X}_{m + n} ⊕ ( len ( A ) \vert \vert len ( C ) ) ) \cdot H & for i = m + n + 1 \end{matrix}$$

where v is the bit length of the final block of A, u is the bit length of the final block of C, denotes concatenation of bit strings, and len(A) and len(C) are the 64-bit representations of the bit lengths of A and C, respectively.

As shown at the bottom portion FIG. 3, during the decompression stage for generating the decompressed raw data stream from the compressed data block, the encrypted header metadata undergoes AES decryption (shown at block 3001) which is authenticated by a comparison (shown at block 3008) of the authentication tag 1025 to a computed tag (block 3007), and the Huffman code trees (shown at block 3002) generated from the header metadata are used to decompress the payload by the Huffman decoding (shown at block 3003) and the LZ77 decoding (shown at block 3004). For the encrypted payload portion defined by the BOE token 1023 and EOE token 1024, the BOE and EOE tokens are tracked (block 3005) during decompression, such that the encrypted payload portion defined by the BOE and EOE is AES-decrypted (block 3001) and decoded using Huffman decoding (block 3003) and LZ77 decoding (block 3004). In addition, as noted above, the authentication tag is computed (block 3007) by the receiver and compared (at block 3008) to tag 1025 that immediately follows EOB token 1016, and the authentication is successful if there is a match (block 3009).

With general reference to notations and nomenclature used herein, portions of the detailed description that follow may be presented in terms of program procedures executed on a computer or network of computers. These procedural descriptions and representations are used by those skilled in the art to most effectively convey the substance of their work to others skilled in the art A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. The apparatus may be specially constructed for the required purpose or may incorporate a general computing device. The required structure for a variety of these machines will appear from the description given.

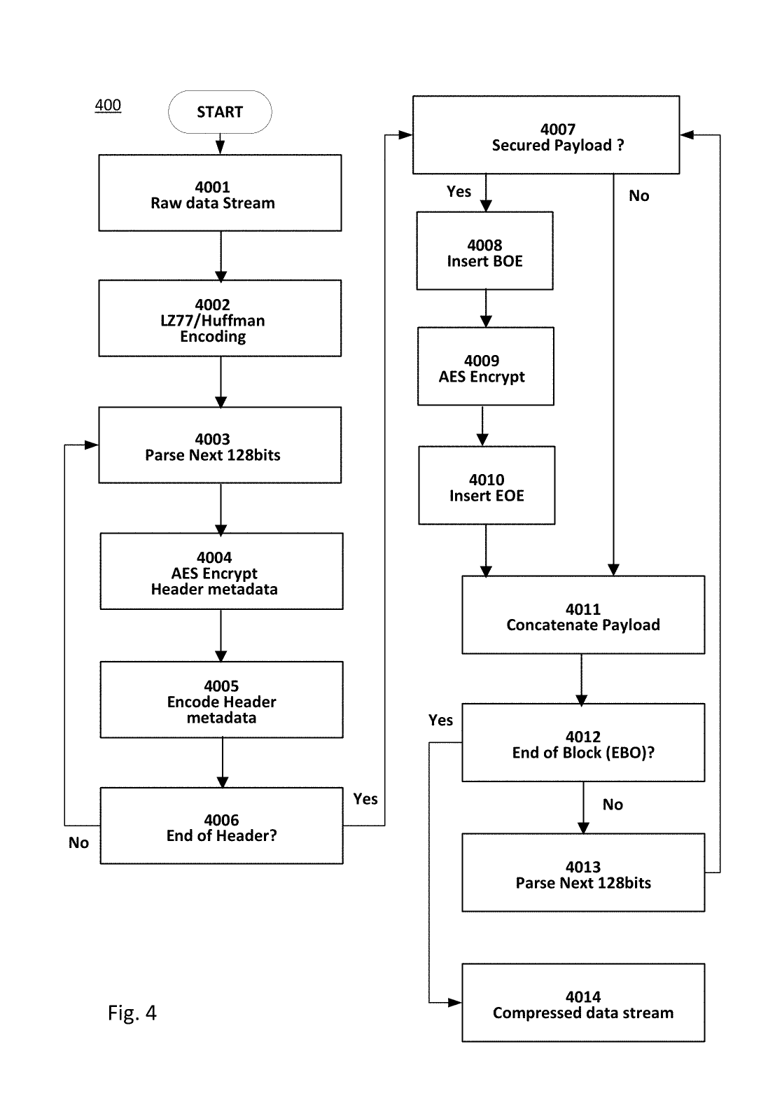

FIG. 4 illustrates an embodiment of logic flow 400 to provide a unified compression-encryption of a raw data block. The raw data block (or raw “data stream”) (shown at block 4001 of FIG. 4) is subjected to LZ77 and Huffman encoding (block 4002) to generate the Huffman codes according to DEFLATE format. It should be note that, in the case that a section of the payload is to be secured, BOE and EOE tokens identifying the secured payload section are also generated during the Huffman encoding at block 4002. The header is protected with 128b encryption, for example, which involves parsing 128 bits (block 4003) and AES-encrypting the header metadata (block 4004). At block 4005, the header metadata, e.g., Huffman codes, are encoded according to DEFLATE format. Logic blocks 4003-4005 are repeated until the ender of header is reached (bock 4006).

Moving to block 4007 in FIG. 4, if the payload (e.g., the actual compressed data) is to be unsecured (plain payload), the plain payload is concatenated to the header metadata (block 4011) by parsing 128 bits at a time (block 4013) until the end of block (EOB) is reached (block 4012). If, on the other hand, a selected portion of the payload is to be secured, BOE token is inserted (block 4008) to mark the beginning of the selected payload portion, the selected payload portion is AES-encrypted (block 4009), EOE token is inserted (block 4010) at the end of the secured, selected payload portion, and the secured, selected payload portion is concatenated to the header metadata (block 4011). Blocks 4008-4011 are repeated by parsing 128 bits at a time (block 4013) until the end of block (EOB) is reached (block 4012). When the end of block (EOB) is reached, the compressed data stream (including the header metadata and the payload of actual compressed data) corresponding to the raw data stream is defined (block 4014).

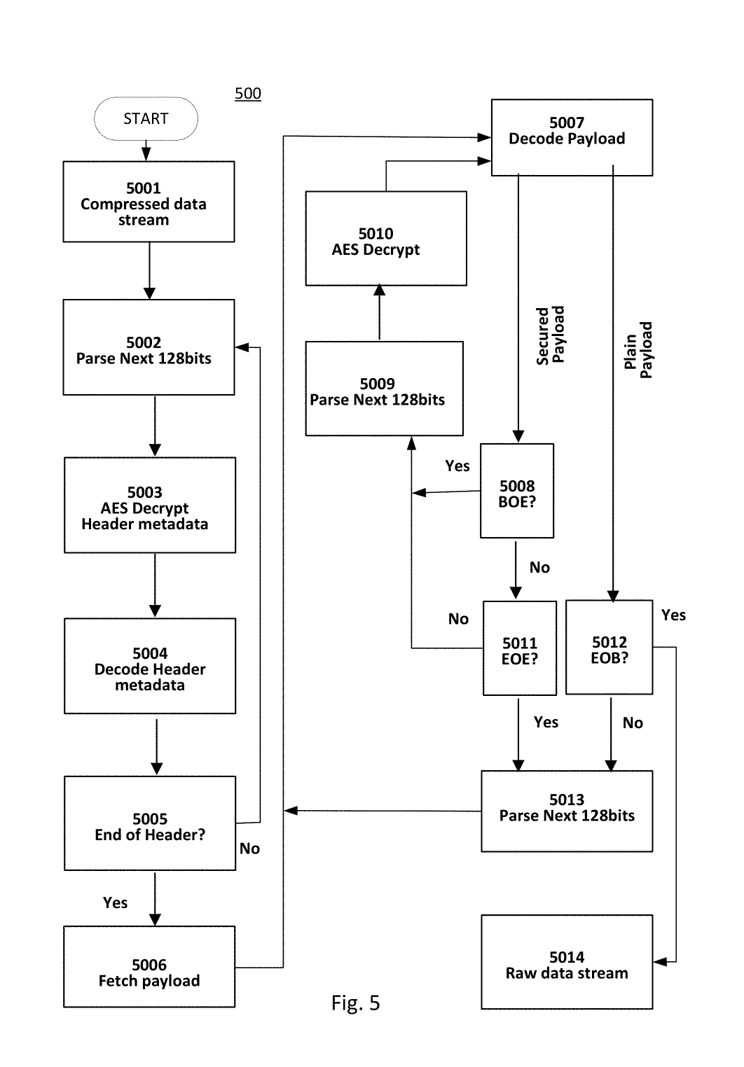

FIG. 5 illustrates an embodiment of logic flow 500 to provide a decompression-decryption of data which had been compressed and encrypted in accordance with the embodiment shown in FIG. 4. The compressed data stream (shown at block 5001 of FIG. 5) is parsed 128 bits at a time (block 5002), and the header metadata is AES-decrypted (block 5003) and decoded (block 5004), e.g., Huffman decoded to generate the Huffman trees. Logic blocks 5002-5004 are repeated until the end of header metadata is reached (block 5005), at which point the payload is fetched (block 5006).

Moving to “decode payload” block 5007 in FIG. 5, if the payload (e.g., the actual compressed data) is unsecured (plain payload), the plain payload is decoded (block 5007), e.g., Huffman-decoded and LZ77-decoded according to DEFLATE format, by parsing 128 bits ata time (block 5013) until the end of block (EOB) is reached (block 5012). If, on the other hand, a portion of the payload is secured (e.g., AES-encrypted), starting with BOE (block 5008) which marks the beginning of the secured payload portion, the secured payload portion is AES-decrypted (block 5010) 128 bits at a time (block 5009) and then decoded (block 5007), e.g., Huffman-decoded and LZ77-decoded according to DEFLATE format, until EOE (block 5011) marking the end of the secured payload portion is reached. Blocks 5007-5013 are repeated by parsing 128 bits at a time (block 5013) until the end of block (EOB) is reached (block 4012). When the end of block (EOB) is reached, the full decompressed raw data stream is present.

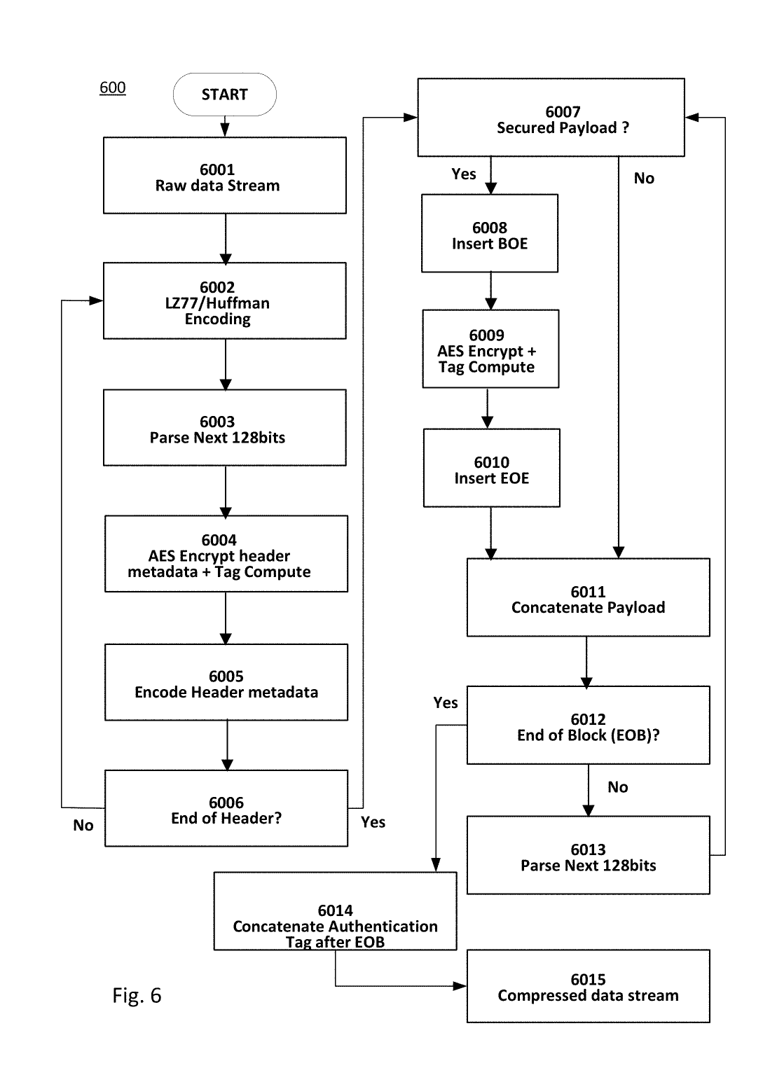

FIG. 6 illustrates an embodiment of logic flow 600 to provide a unified compression-encryption of a raw data block, with the addition of an authentication tag. The raw data block (or raw “data stream”) (shown at block 6001 of FIG. 4) is subjected to LZ77 and Huffman encoding (block 6002) to generate the Huffman codes according to DEFLATE format. It should be note that, in the case that a section of the payload is to be secured, BOE and EOE tokens identifying the secured payload section are also generated during the Huffman encoding at block 6002. The header is protected with 128b encryption, for example, which involves parsing 128 bits (block 6003) and AES-encrypting the header metadata (block 6004). At block 6004, the authentication tag (e.g., tag 1025 described above in connection with FIG. 3) generation is also performed, e.g., using GCM discussed above. At block 6005, the header metadata, e.g., Huffman codes, are encoded according to DEFLATE format. Logic blocks 6003-6005 are repeated until the ender of header is reached (bock 6006).

Moving to block 6007 in FIG. 6, if the payload (e.g., the actual compressed data) is to be unsecured (plain payload), the plain payload is concatenated to the header metadata (block 6011) by parsing 128 bits at a time (block 6013) until the end of block (EOB) is reached (block 6012). If, on the other hand, a selected portion of the payload is to be secured, BOE token is inserted (block 6008) to mark the beginning of the selected payload portion, the selected payload portion is AES-encrypted along with further computation of the authentication tag (block 6009), EOE token is inserted (block 6010) at the end of the secured, selected payload portion, and the secured, selected payload portion is concatenated to the header metadata (block 6011). Blocks 6008-6011 are repeated by parsing 128 bits ata time (block 6013) until the end of block (EOB) is reached (block 6012), at which point the computed authentication tag is concatenated to EOB (block 6014). With the concatenation of the authentication tag to EOB, the compressed data stream (including the header metadata, the payload of actual compressed data, and the authentication tag) is present (block 6015).

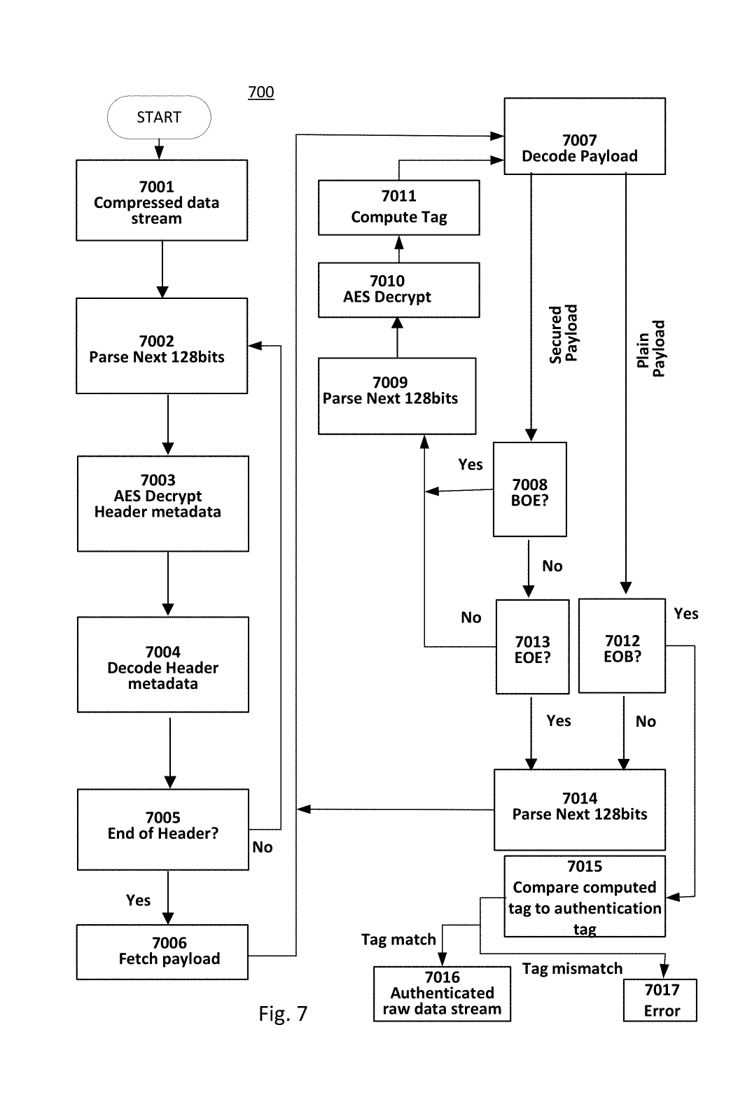

FIG. 7 illustrates an embodiment of logic flow 700 to provide a decompression-decryption and authentication of data which had been compressed and encrypted in accordance with the embodiment shown in FIG. 6. The compressed data stream (shown at block 7001 of FIG. 7) is parsed 128 bits at a time (block 7002), and the header metadata is AES-decrypted (block 7003) and decoded (block 7004), e.g., Huffman decoded to generate the Huffman trees. Logic blocks 7002-7004 are repeated until the end of header metadata is reached (block 7005), at which point the payload is fetched (block 7006).

Moving to “decode payload” block 7007 in FIG. 7, if the payload (e.g., the actual compressed data) is unsecured (plain payload), the plain payload is decoded (block 7007), e.g., Huffman-decoded and LZ77-decoded according to DEFLATE format, by parsing 128 bits at a time (block 7014) until the end of block (EOB) is reached (block 7012). If, on the other hand, a portion of the payload is secured (e.g., AES-encrypted), starting with BOE (block 7008) which marks the beginning of the secured payload portion, the secured payload portion is AES-decrypted (block 7010) and computation of the authentication tag (block 7011) is performed 128 bits at a time (block 7009), e.g., using GCM discussed above in connection with FIG. 3, and then decoded (block 7007), e.g., Huffman-decoded and LZ77-decoded according to DEFLATE format, until EOE (block 7013) marking the end of the secured payload portion is reached. Blocks 7007-7014 are repeated by parsing 128 bits ata time (block 7009) until the end of block (EOB) is reached (block 7012), at which point the computed authentication tag is compared to the authentication tag following the EOB token (block 7015). If the compared tags match, then authenticated raw data stream is present (block 7016). If the compared tags do not match, then an error is present (block 7017).

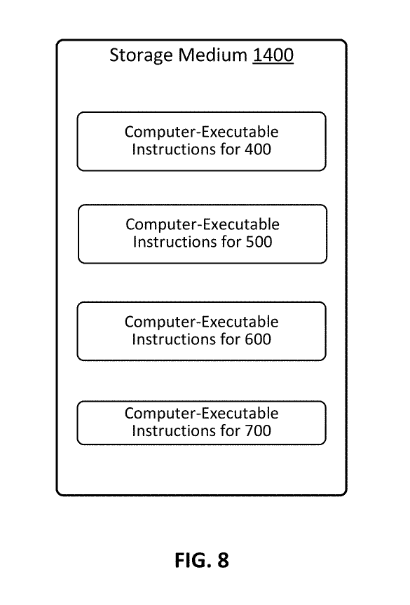

FIG. 8 illustrates an embodiment of a storage medium 1400. Storage medium 1400 may comprise any computer-readable storage medium or machine-readable storage medium, such as an optical, magnetic or semiconductor storage medium. In some embodiments, storage medium 1400 may comprise a non-transitory storage medium. In various embodiments, storage medium 1400 may comprise an article of manufacture. In some embodiments, storage medium 1400 may store computer-executable instructions, such as computer-executable instructions to implement one or more of logic flows 400, 500, 600 and 700. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited to these examples.

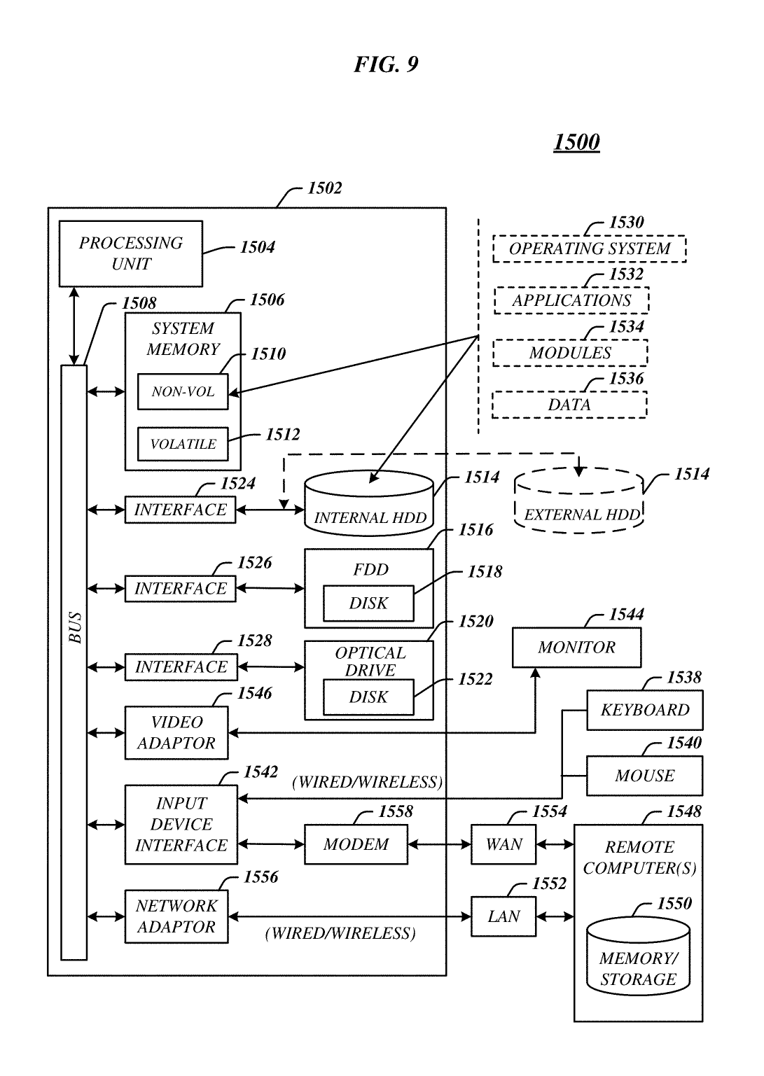

FIG. 9 illustrates an embodiment of an exemplary computing architecture 1500 that may be suitable for implementing various embodiments as previously described. In various embodiments, the computing architecture 1500 may comprise or be implemented as part of an electronic device. In some embodiments, the computing architecture 1500 may be representative, for example, of a computing device suitable for use in conjunction with implementation of one or more of logic flow 400, logic flow 500, logic flow 600, and logic flow 700. The embodiments are not limited in this context

As used in this application, the terms “system” and “component” and “module” are intended to refer to a computer-related entity, either hardware, a combination of hardware and software, software, or software in execution, examples of which are provided by the exemplary computing architecture 1500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1500.

As shown in FIG. 9, according to computing architecture 1500, a computer 1502 comprises a processing unit 1504, a system memory 1506 and a system bus 1508. In some embodiments, computer 1502 may comprise a server. In some embodiments, computer 1502 may comprise a client. The processing unit 1504 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1504.

The system bus 1508 provides an interface for system components including, but not limited to, the system memory 1506 to the processing unit 1504. The system bus 1508 can be any of several types of bus structure that may further interconnect to a memory bus (with or without a memory controller), a peripheral bus, and a local bus using any of a variety of commercially available bus architectures. Interface adapters may connect to the system bus 1508 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 1506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 1506 can include non-volatile memory 1510 and/or volatile memory 1512. A basic input/output system (BIOS) can be stored in the non-volatile memory 1510.

The computer 1502 may include various types of computer-readable storage media in the form of one or more lower speed memory units, including an internal (or external) hard disk drive (HDD) 1514, a magnetic floppy disk drive (FDD) 1516 to read from or write to a removable magnetic disk 1518, and an optical disk drive 1520 to read from or write to a removable optical disk 1522 (e.g., a CD-ROM or DVD). The HDD 1514, FDD 1516 and optical disk drive 1520 can be connected to the system bus 1508 by a HDD interface 1524, an FDD interface 1526 and an optical drive interface 1528, respectively. The HDD interface 1524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1510, 1512, including an operating system 1530, one or more application programs 1532, other program modules 1534, and program data 1536.

A user can enter commands and information into the computer 1502 through one or more wire/wireless input devices, for example, a keyboard 1538 and a pointing device, such as a mouse 1540. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1504 through an input device interface 1542 that is coupled to the system bus 1508, but can be connected by other interfaces such as a parallel port, IEEE 1394 serial port, a game port, a USB port, an IR interface, and so forth.

A monitor 1544 or other type of display device is also connected to the system bus 1508 via an interface, such as a video adaptor 1546. The monitor 1544 may be internal or external to the computer 1502. In addition to the monitor 1544, a computer typically includes other peripheral output devices, such as speakers, printers, and so forth.

The computer 1502 may operate in a networked environment using logical connections via wire and/or wireless communications to one or more remote computers, such as a remote computer 1548. The remote computer 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wire/wireless connectivity to a local area network (LAN) 1552 and/or larger networks, for example, a wide area network (WAN) 1554. Such LAN and WAN networking environments are commonplace in offices and companies, and facilitate enterprise-wide computer networks, such as intranets, all of which may connect to a global communications network, for example, the Internet.

When used in a LAN networking environment, the computer 1502 is connected to the LAN 1552 through a wire and/or wireless communication network interface or adaptor 1556. The adaptor 1556 can facilitate wire and/or wireless communications to the LAN 1552, which may also include a wireless access point disposed thereon for communicating with the wireless functionality of the adaptor 1556.

When used in a WAN networking environment, the computer 1502 can include a modem 1558, or is connected to a communications server on the WAN 1554, or has other means for establishing communications over the WAN 1554, such as by way of the Internet The modem 1558, which can be internal or external and a wire and/or wireless device, connects to the system bus 1508 via the input device interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

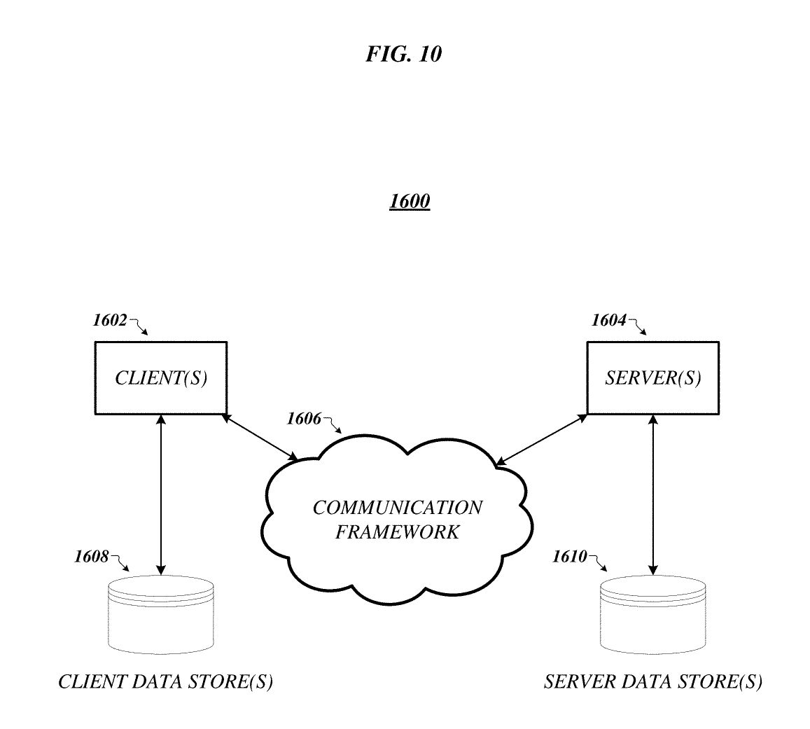

FIG. 10 illustrates a block diagram of an exemplary communications architecture 1600 suitable for implementing various embodiments as previously described. The communications architecture 1600 includes various common communications elements, such as a transmitter, receiver, transceiver, radio, network interface, baseband processor, antenna, amplifiers, filters, power supplies, and so forth. The embodiments, however, are not limited to implementation by the communications architecture 1600.

As shown in FIG. 10, the communications architecture 1600 comprises includes one or more clients 1602 and servers 1604. The clients 1602 and the servers 1604 are operatively connected to one or more respective client data stores 1608 and server data stores 1610 that can be employed to store information local to the respective clients 1602 and servers 1604, such as cookies and/or associated contextual information. Any one of clients 1602 and/or servers 1604 may implement one or more of logic flow 400, logic flow 500, logic flow 600, and computing architecture 1500.

The clients 1602 and the servers 1604 may communicate information between each other using a communication framework 1606. The communications framework 1606 may implement any well-known communications techniques and protocols. The communications framework 1606 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1606 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1602 and the servers 1604. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

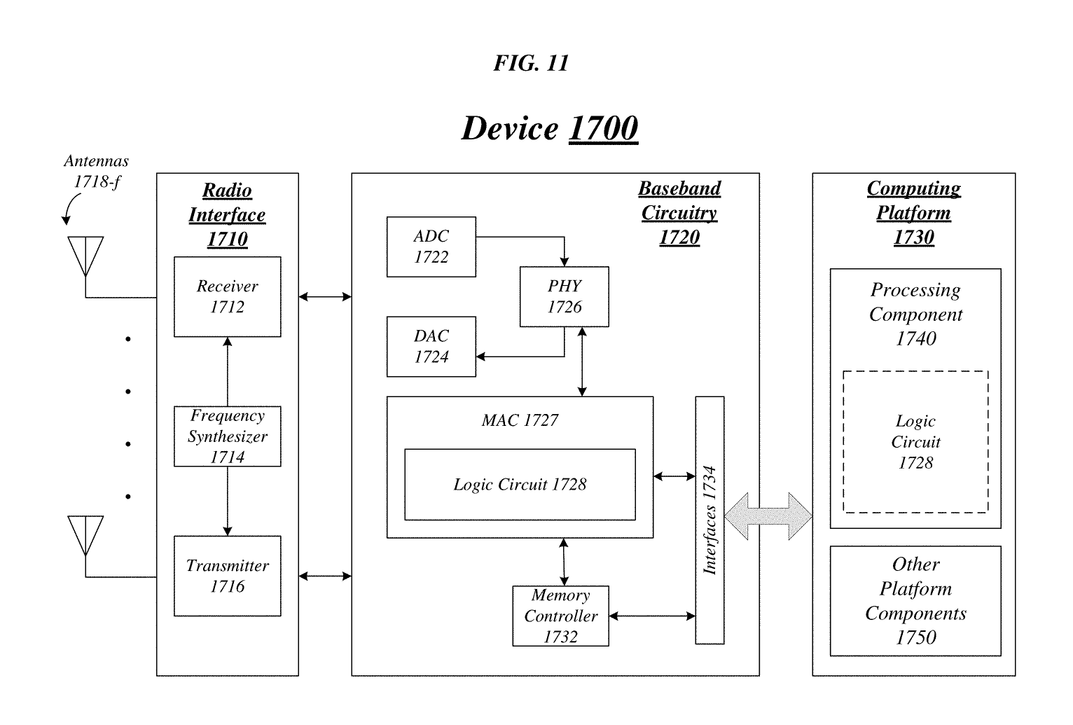

FIG. 11 illustrates an embodiment of a communications device 1700 that may implement one or more of logic flow 400, logic flow 500, logic flow 600, logic flow 700, CLCAM 1040, LLCAM 1041, DCAM 1042, buffer 1043, storage medium 1400, and computing architecture 1500 according to some embodiments. In various embodiments, device 1700 may comprise a logic circuit 1728. The logic circuit 1728 may include physical circuits to perform operations described for one or more of logic flow 400, logic flow 500, logic flow 600, and logic flow 700, for example. As shown in FIG. 11, device 1700 may include a radio interface 1710, baseband circuitry 1720, and computing platform 1730, although the embodiments are not limited to this configuration.

The device 1700 may implement some or all of the structure and/or operations for one or more of logic flow 400, logic flow 500, logic flow 600, logic flow 700, CLCAM 1040, LLCAM 1041, DCAM 1042, buffer 1043, storage medium 1400, computing architecture 1500, and logic circuit 1728 in a single computing entity, such as entirely within a single device. Alternatively, the device 1700 may distribute portions of the structure and/or operations for one or more of logic flow 400, logic flow 500, logic flow 600, logic flow 700, CLCAM 1040, LLCAM 1041, DCAM 1042, buffer 1043, storage medium 1400, computing architecture 1500, and logic circuit 1728 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context

In one embodiment, radio interface 1710 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 1710 may include, for example, a receiver 1712, a frequency synthesizer 1714, and/or a transmitter 1716. Radio interface 1710 may include bias controls, a crystal oscillator and/or one or more antennas 1718-f. In another embodiment, radio interface 1710 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1720 may communicate with radio interface 1710 to process receive and/or transmit signals and may include, for example, a mixer for down-converting received RF signals, an analog-to-digital converter 1722 for converting analog signals to digital form, a digital-to-analog converter 1724 for converting digital signals to analog form, and a mixer for up-converting signals for transmission. Further, baseband circuitry 1720 may include a baseband or physical layer (PHY) processing circuit 1726 for PHY link layer processing of respective receive/transmit signals. Baseband circuitry 1720 may include, for example, a medium access control (MAC) processing circuit 1727 for MAC/data link layer processing. Baseband circuitry 1720 may include a memory controller 1732 for communicating with MAC processing circuit 1727 and/or a computing platform 1730, for example, via one or more interfaces 1734.

In some embodiments, PHY processing circuit 1726 may include a frame construction and/or detection module, in combination with additional circuitry such as a buffer memory, to construct and/or deconstruct communication frames. Alternatively, or in addition, MAC processing circuit 1727 may share processing for certain of these functions or perform these processes independent of PHY processing circuit 1726. In some embodiments, MAC and PHY processing may be integrated into a single circuit

The computing platform 1730 may provide computing functionality for the device 1700. As shown, the computing platform 1730 may include a processing component 1740. In addition to, or alternatively of, the baseband circuitry 1720, the device 1700 may execute processing operations or logic for one or more of logic flow 400, logic flow 500, logic flow 600, logic flow 700, CLCAM 1040, LLCAM 1041, DCAM 1042, buffer 1043, storage medium 1400, computing architecture 1500, and logic circuit 1728 using the processing component 1740. The processing component 1740 (and/or PHY 1726 and/or MAC 1727) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1730 may further include other platform components 1750. Other platform components 1750 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1700 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 1700 described herein, may be included or omitted in various embodiments of device 1700, as suitably desired.

Embodiments of device 1700 may be implemented using single input single output (SISO) architectures. However, certain implementations may include multiple antennas (e.g., antennas 1718-f) for transmission and/or reception using adaptive antenna techniques for beamforming or spatial division multiple access (SDMA) and/or using MIMO communication techniques.

The components and features of device 1700 may be implemented using any combination of discrete circuitry, application specific integrated circuits (ASICs), logic gates and/or single chip architectures. Further, the features of device 1700 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit”

It should be appreciated that the exemplary device 1700 shown in the block diagram of FIG. 11 may represent one functionally descriptive example of many potential implementations. Accordingly, division, omission or inclusion of block functions depicted in the accompanying figures does not infer that the hardware components, circuits, software and/or elements for implementing these functions would be necessarily divided, omitted, or included in embodiments.

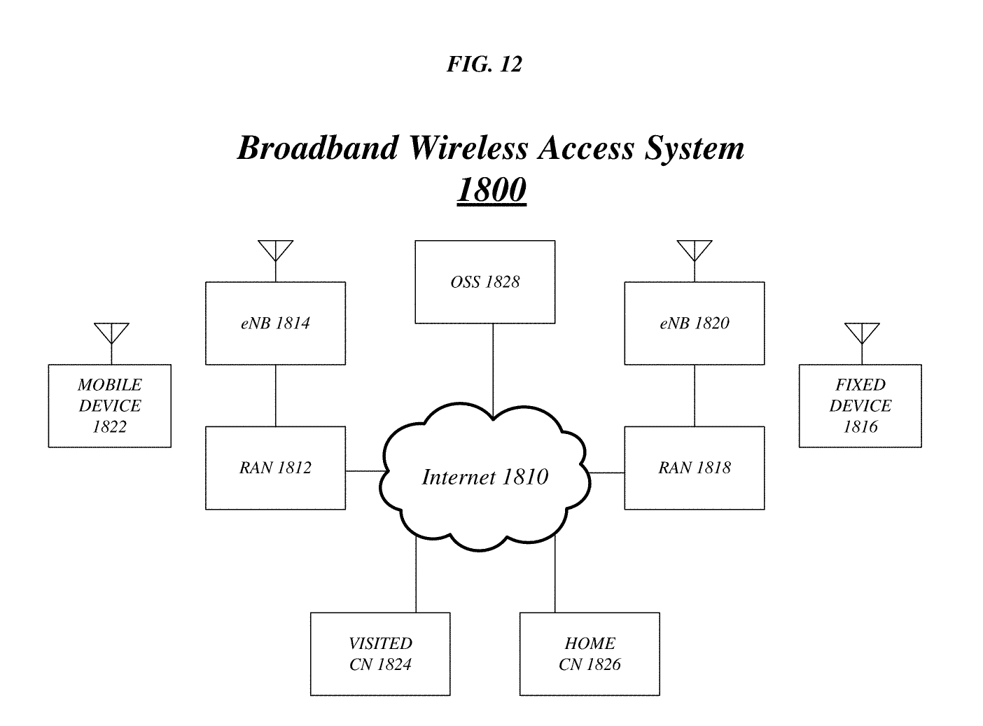

FIG. 12 illustrates an embodiment of a broadband wireless access system 1800. As shown in FIG. 12, broadband wireless access system 1800 may be an internet protocol (IP) type network comprising an internet 1810 type network or the like that is capable of supporting mobile wireless access and/or fixed wireless access to internet 1810. In one or more embodiments, broadband wireless access system 1800 may comprise any type of orthogonal frequency division multiple access (OFDMA)-based or single-carrier frequency division multiple access (SC-FDMA)-based wireless network, such as a system compliant with one or more of the 3GPP LTE Specifications and/or IEEE 802.16 Standards, and the scope of the claimed subject matter is not limited in these respects.

In the exemplary broadband wireless access system 1800, radio access networks (RANs) 1812 and 1818 are capable of coupling with evolved node Bs (eNBs) 1814 and 1820, respectively, to provide wireless communication between one or more fixed devices 1816 and internet 1810 and/or between or one or more mobile devices 1822 and Internet 1810. One example of a fixed device 1816 and a mobile device 1822 is device 1700 of FIG. 11, with the fixed device 1816 comprising a stationary version of device 1700 and the mobile device 1822 comprising a mobile version of device 1700. RANs 1812 and 1818 may implement profiles that are capable of defining the mapping of network functions to one or more physical entities on broadband wireless access system 1800. eNBs 1814 and 1820 may comprise radio equipment to provide RF communication with fixed device 1816 and/or mobile device 1822, such as described with reference to device 1700, and may comprise, for example, the PHY and MAC layer equipment in compliance with a 3GPP LTE Specification or an IEEE 802.16 Standard. eNBs 1814 and 1820 may further comprise an IP backplane to couple to Internet 1810 via RANs 1812 and 1818, respectively, although the scope of the claimed subject matter is not limited in these respects.

Broadband wireless access system 1800 may further comprise a visited core network (CN) 1824 and/or a home CN 1826, each of which may be capable of providing one or more network functions including but not limited to proxy and/or relay type functions, for example authentication, authorization and accounting (AAA) functions, dynamic host configuration protocol (DHCP) functions, or domain name service controls or the like, domain gateways such as public switched telephone network (PSTN) gateways or voice over internet protocol (VoIP) gateways, and/or internet protocol (IP) type server functions, or the like. However, these are merely example of the types of functions that are capable of being provided by visited CN 1824 and/or home CN 1826, and the scope of the claimed subject matter is not limited in these respects. Visited CN 1824 may be referred to as a visited CN in the case where visited CN 1824 is not part of the regular service provider of fixed device 1816 or mobile device 1822, for example where fixed device 1816 or mobile device 1822 is roaming away from its respective home CN 1826, or where broadband wireless access system 1800 is part of the regular service provider of fixed device 1816 or mobile device 1822 but where broadband wireless access system 1800 may be in another location or state that is not the main or home location of fixed device 1816 or mobile device 1822. The embodiments are not limited in this context

Fixed device 1816 may be located anywhere within range of one or both of eNBs 1814 and 1820, such as in or near a home or business to provide home or business customer broadband access to Internet 1810 via eNBs 1814 and 1820 and RANs 1812 and 1818, respectively, and home CN 1826. It is worthy of note that although fixed device 1816 is generally disposed in a stationary location, it may be moved to different locations as needed. Mobile device 1822 may be utilized at one or more locations if mobile device 1822 is within range of one or both of eNBs 1814 and 1820, for example. In accordance with one or more embodiments, operation support system (OSS) 1828 may be part of broadband wireless access system 1800 to provide management functions for broadband wireless access system 1800 and to provide interfaces between functional entities of broadband wireless access system 1800. Broadband wireless access system 1800 of FIG. 12 is merely one type of wireless network showing a certain number of the components of broadband wireless access system 1800, and the scope of the claimed subject matter is not limited in these respects.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The disclosure now turns to providing various examples implementations. The examples provided below are not intended to be limiting.

Example 1. An apparatus, comprising: a memory; and logic, at least a portion of which is implemented in circuitry coupled to the memory, the logic to: receive a data block; compress the data block using a data-compression technique to generate a compressed data block having multiple portions, with one portion comprising compressed data and another portion comprising metadata associated with the compressed data; and encrypt selective portions of the compressed data block using an encryption technique, the selective portions comprising at least a portion of the metadata.

Example 2. The apparatus of Example 1, the logic to encrypt at least one selected portion of the compressed data using the encryption technique.

Example 3. The apparatus of Example 2, the logic to: incorporate a beginning-of-encryption (BOE) token at the beginning of the at least one selected portion of the compressed data; and incorporate an end-of-encryption (EOE) token at the end of the at least one selected portion of the compressed data.

Example 4. The apparatus of Example 1, the logic to: incorporate an end-of-block (EOB) token at the end of the compressed data block; and incorporate an authentication tag after the EOB token.

Example 5. The apparatus of Example 1, the logic to one of (a) encrypt at least one selected portion of the compressed data using Advanced Encryption Standard (AES), or (b) compress the data block using DEFLATE data compression format, the metadata comprising a header sequence of DEFLATE data compression format

Example 6. The apparatus of Example 1, the logic to compress the data block using Huffman coding, the metadata comprising Huffman codes for interpreting the compressed data.

Example 7. The apparatus of Example 1, the logic comprising at least a portion of a radio frequency (RF) communication device, the logic to transmit the compressed data block.

Example 8. At least one non-transitory machine-readable storage medium comprising instructions that, when executed by a processor element, cause the processor element to: receive a data block; compress the data block using a data-compression technique to generate a compressed data block having multiple portions, with one portion comprising compressed data and another portion comprising metadata associated with the compressed data; and encrypt selective portions of the compressed data block using an encryption technique, the selective portions comprising at least a portion of the metadata.

Example 9. The at least one non-transitory machine-readable storage medium of Example 8, comprising instructions that, when executed by a processor element, cause the processor element to: encrypt at least one selected portion of the compressed data using the encryption technique.

Example 10. The at least one non-transitory machine-readable storage medium of Example 9, comprising instructions that, when executed by a processor element, cause the processor element to: incorporate a beginning-of-encryption (BOE) token at the beginning of the at least one selected portion of the compressed data; and incorporate an end-of-encryption (EOE) token at the end of the at least one selected portion of the compressed data.

Example 11. The at least one non-transitory machine-readable storage medium of Example 8, comprising instructions that, when executed by a processor element, cause the processor element to: incorporate an end-of-block (EOB) token at the end of the compressed data block; and incorporate an authentication tag after the EOB token.

Example 12. The at least one non-transitory machine-readable storage medium of Example 8, comprising instructions that, when executed by a processor element, cause the processor element to one of: a) encrypt at least one selected portion of the compressed data using Advanced Encryption Standard (AES); orb) compress the data block using DEFLATE data compression format, the metadata comprising a header sequence of DEFLATE data compression format.

Example 13. The at least one non-transitory machine-readable storage medium of Example 8, comprising instructions that, when executed by a processor element, cause the processor element to: compress the data block using Huffman coding, the metadata comprising Huffman codes for interpreting the compressed data.

Example 14. The at least one non-transitory machine-readable storage medium of Example 8, comprising instructions that, when executed by a processor element, cause the processor element to: transmit the compressed data block to a receiver.

Example 15. An apparatus, comprising: a memory; and logic, at least a portion of which is implemented in circuitry coupled to the memory, the logic to: receive a compressed data block generated from a data block using a data-compression technique, the compressed data block having multiple portions, with one portion comprising compressed data and another portion comprising metadata associated with the compressed data, and selective portions of the compressed data block encrypted using an encryption technique, the selective portions comprising at least a portion of the metadata; decrypt the selective portions of the compressed data block; and decompress the compressed data with the aid of the metadata.

Example 16. The apparatus of Example 15, the selective portions comprising at least one selected portion of the compressed data encrypted using the encryption technique.

Example 17. The apparatus of Example 16, a beginning-of-encryption (BOE) token provided at the beginning of the at least one selected portion of the compressed data, an end-of-encryption (EOE) token provided at the end of the at least one selected portion of the compressed data, the logic to additionally decrypt the at least one selected portion of the compressed data bounded by the BOE token and the EOE token.

Example 18. The apparatus of Example 15, an end-of-block (EOB) token incorporated at the end of the compressed data block, and a reference authentication tag provided after the EOB token, the logic to compute an authentication tag and compare the computed authentication tag to the reference authentication tag.

Example 19. The apparatus of Example 15, wherein: (a) at least one selected portion of the compressed data is encrypted using Advanced Encryption Standard (AES), or (b) the data block is compressed using DEFLATE data compression format, and the metadata comprising a header sequence of DEFLATE data compression format

Example 20. The apparatus of Example 15, the data block compressed using Huffman coding, and the metadata comprising Huffman codes for interpreting the compressed data.

Example 21. At least one non-transitory machine-readable storage medium comprising instructions that, when executed by a processor element, cause the processor element to: receive a compressed data block generated from a data block using a data-compression technique, the compressed data block having multiple portions, with one portion comprising compressed data and another portion comprising metadata associated with the compressed data, and selective portions of the compressed data block encrypted using an encryption technique, the selective portions comprising at least a portion of the metadata; decrypt the selective portions of the compressed data block; and decompress the compressed data with the aid of the metadata.

Example 22. The at least one non-transitory machine-readable storage medium of Example 21, the selective portions comprising at least one selected portion of the compressed data encrypted using the encryption technique.

Example 23. The at least one non-transitory machine-readable storage medium of Example 22, a beginning-of-encryption (BOE) token provided at the beginning of the at least one selected portion of the compressed data, and an end-of-encryption (EOE) token provided at the end of the at least one selected portion of the compressed data, the at least one non-transitory machine-readable storage medium comprising instructions that, when executed by a processor element, cause the processor element to additionally decrypt the at least one selected portion of the compressed data bounded by the BOE token and the EOE token.

Example 24. The at least one non-transitory machine-readable storage medium of Example 21, an end-of-block (EOB) token incorporated at the end of the compressed data block, and a reference authentication tag provided after the EOB token, the at least one non-transitory machine-readable storage medium comprising instructions that, when executed by a processor element, cause the processor element to compute an authentication tag and compare the computed authentication tag to the reference authentication tag.

Example 25. The at least one non-transitory machine-readable storage medium of Example 21, wherein: a) at least one selected portion of the compressed data encrypted using Advanced Encryption Standard (AES); orb) the data block compressed using DEFLATE data compression format, and the metadata comprising a header sequence of DEFLATE data compression format

Example 26. The at least one non-transitory machine-readable storage medium of Example 21, the data block compressed using Huffman coding, and the metadata comprising Huffman codes for interpreting the compressed data.

Example 27. The at least one non-transitory machine-readable storage medium of Example 21, the at least one selected portion of the compressed data encrypted using Advanced Encryption Standard (AES).

Example 28. A computer-implemented method comprising: receiving a data block; compressing the data block using a data-compression technique to generate a compressed data block having multiple portions, with one portion comprising compressed data and another portion comprising metadata associated with the compressed data; and encrypting selective portions of the compressed data block using an encryption technique, the selective portions comprising at least a portion of the metadata; and transmitting the compressed data block.

Example 29. The method of Example 28, comprising: encrypting at least one selected portion of the compressed data using the encryption technique.

Example 30. The method of Example 29, comprising: incorporating a beginning-of-encryption (BOE) token at the beginning of the at least one selected portion of the compressed data; and incorporating an end-of-encryption (EOE) token at the end of the at least one selected portion of the compressed data.

Example 31. The method of Example 28, comprising: incorporating an end-of-block (EOB) token at the end of the compressed data block; and incorporating an authentication tag after the EOB token.

Example 32. The method of Example 28, wherein: (a) at least one selected portion of the compressed data is encrypted using Advanced Encryption Standard (AES); or (b) the data block is compressed using DEFLATE data compression format, and the metadata comprising a header sequence of DEFLATE data compression format

Example 33. The method of Example 28, the data block compressed using Huffman coding, and the metadata comprising Huffman codes for interpreting the compressed data.

Example 34. The method of Example 29, the at least one selected portion of the compressed data encrypted using Advanced Encryption Standard (AES).

Example 35. The method of Example 29, the data block compressed using DEFLATE data compression format, and the metadata comprising a header sequence of DEFLATE data compression format

Example 36. The method of Example 29, the data block compressed using Huffman coding, and the metadata comprising Huffman codes for interpreting the compressed data.

Example 37. The method of Example 33, the data block compressed using DEFLATE data compression format, and the metadata comprising a header sequence of DEFLATE data compression format

Example 38. The method of Example 33, the data block compressed using Huffman coding, and the metadata comprising Huffman codes for interpreting the compressed data.

Example 39. The apparatus of Example 2, the logic to: incorporate an end-of-block (EOB) token at the end of the compressed data block; and incorporate an authentication tag after the EOB token.

Example 40. The apparatus of Example 2, the logic to encrypt the at least one selected portion of the compressed data using Advanced Encryption Standard (AES).

Example 41. The apparatus of Example 2, the logic to compress the data block using DEFLATE data compression format, the metadata comprising a header sequence of DEFLATE data compression format.

Example 42. The apparatus of Example 2, the logic to compress the data block using Huffman coding, the metadata comprising Huffman codes for interpreting the compressed data.

Example 43. The apparatus of Example 2, the logic comprising at least a portion of a radio frequency (RF) communication device, the logic to transmit the compressed data block.

Example 44. The apparatus of Example 39, the logic to encrypt the at least one selected portion of the compressed data using Advanced Encryption Standard (AES).

Example 45. The apparatus of Example 39, the logic to compress the data block using DEFLATE data compression format, the metadata comprising a header sequence of DEFLATE data compression format.

Example 46. The apparatus of Example 39, the logic to compress the data block using Huffman coding, the metadata comprising Huffman codes for interpreting the compressed data.

Example 47. The apparatus of Example 39, the logic comprising at least a portion of a radio frequency (RF) communication device, the logic to transmit the compressed data block.

Example 48. The at least one non-transitory machine-readable storage medium of Example 9, comprising instructions that, when executed by a processor element, cause the processor element to: incorporate an end-of-block (EOB) token at the end of the compressed data block; and incorporate an authentication tag after the EOB token.

Example 49. The at least one non-transitory machine-readable storage medium of Example 9, comprising instructions that, when executed by a processor element, cause the processor element to: encrypt the at least one selected portion of the compressed data using Advanced Encryption Standard (AES).

Example 50. The at least one non-transitory machine-readable storage medium of Example 9, comprising instructions that, when executed by a processor element, cause the processor element to: compress the data block using DEFLATE data compression format, the metadata comprising a header sequence of DEFLATE data compression format.

Example 51. The at least one non-transitory machine-readable storage medium of Example 9, comprising instructions that, when executed by a processor element, cause the processor element to: compress the data block using Huffman coding, the metadata comprising Huffman codes for interpreting the compressed data.

Example 52. The at least one non-transitory machine-readable storage medium of Example 9, comprising instructions that, when executed by a processor element, cause the processor element to: transmit the compressed data block to a receiver.

Example 53. The at least one non-transitory machine-readable storage medium of Example 48, comprising instructions that, when executed by a processor element, cause the processor element to: encrypt the at least one selected portion of the compressed data using Advanced Encryption Standard (AES).

Example 54. The at least one non-transitory machine-readable storage medium of Example 48, comprising instructions that, when executed by a processor element, cause the processor element to: compress the data block using DEFLATE data compression format, the metadata comprising a header sequence of DEFLATE data compression format.

Example 55. The at least one non-transitory machine-readable storage medium of Example 48, comprising instructions that, when executed by a processor element, cause the processor element to: compress the data block using Huffman coding, the metadata comprising Huffman codes for interpreting the compressed data.

Example 56. The at least one non-transitory machine-readable storage medium of Example 48, comprising instructions that, when executed by a processor element, cause the processor element to: transmit the compressed data block to a receiver.

Example 57. The apparatus of Example 15, the logic comprising at least a portion of a radio frequency (RF) communication device to receive the compressed data block.

Example 58. The apparatus of Example 16, an end-of-block (EOB) token incorporated at the end of the compressed data block, and a reference authentication tag provided after the EOB token, the logic to compute an authentication tag and compare the computed authentication tag to the reference authentication tag.

Example 59. The apparatus of Example 16, the at least one selected portion of the compressed data encrypted using Advanced Encryption Standard (AES).

Example 60. The apparatus of Example 16, the data block compressed using DEFLATE data compression format, and the metadata comprising a header sequence of DEFLATE data compression format.

Example 61. The apparatus of Example 16, the data block compressed using Huffman coding, and the metadata comprising Huffman codes for interpreting the compressed data.

Example 62. The apparatus of Example 16, the logic comprising at least a portion of a radio frequency (RF) communication device to receive the compressed data block.

Example 63. The apparatus of Example 58, the at least one selected portion of the compressed data encrypted using Advanced Encryption Standard (AES).

Example 64. The apparatus of Example 58, the data block compressed using DEFLATE data compression format, and the metadata comprising a header sequence of DEFLATE data compression format.

Example 65. The apparatus of Example 58, the data block compressed using Huffman coding, and the metadata comprising Huffman codes for interpreting the compressed data.

Example 66. The apparatus of Example 58, the logic comprising at least a portion of a radio frequency (RF) communication device to receive the compressed data block.

Example 67. The at least one non-transitory machine-readable storage medium of Example 22, an end-of-block (EOB) token incorporated at the end of the compressed data block, and a reference authentication tag provided after the EOB token, the at least one non-transitory machine-readable storage medium comprising instructions that, when executed by a processor element, cause the processor element to compute an authentication tag and compare the computed authentication tag to the reference authentication tag.

Example 68. The at least one non-transitory machine-readable storage medium of Example 22, the data block compressed using DEFLATE data compression format, and the metadata comprising a header sequence of DEFLATE data compression format.

Example 69. The at least one non-transitory machine-readable storage medium of Example 22, the data block compressed using Huffman coding, and the metadata comprising Huffman codes for interpreting the compressed data.

Example 70. The at least one non-transitory machine-readable storage medium of Example 22, the at least one selected portion of the compressed data encrypted using Advanced Encryption Standard (AES).

Example 71. The at least one non-transitory machine-readable storage medium of Example 67, the data block compressed using DEFLATE data compression format, and the metadata comprising a header sequence of DEFLATE data compression format.

Example 72. The at least one non-transitory machine-readable storage medium of Example 67, the data block compressed using Huffman coding, and the metadata comprising Huffman codes for interpreting the compressed data.

Example 73. The at least one non-transitory machine-readable storage medium of Example 67, the at least one selected portion of the compressed data encrypted using Advanced Encryption Standard (AES).

Example 74. An apparatus for secured data compression, comprising: a data storage means; and a logic means, at least a portion of which is implemented in circuitry coupled to the data storage means, the logic means to: receive a data block; compress the data block using a data-compression technique to generate a compressed data block having multiple portions, with one portion comprising compressed data and another portion comprising metadata associated with the compressed data; and encrypt selective portions of the compressed data block using an encryption technique, the selective portions comprising at least a portion of the metadata.

Example 75. The apparatus of Example 74, the logic means to encrypt at least one selected portion of the compressed data using the encryption technique.

Example 76. The apparatus of Example 75, the logic means to: incorporate a beginning-of-encryption (BOE) token at the beginning of the at least one selected portion of the compressed data; and incorporate an end-of-encryption (EOE) token at the end of the at least one selected portion of the compressed data.

Example 77. The apparatus of Example 74, the logic means to: incorporate an end-of-block (EOB) token at the end of the compressed data block; and incorporate an authentication tag after the EOB token.

Example 78. The apparatus of Example 77, the logic means to one of (a) encrypt at least one selected portion of the compressed data using Advanced Encryption Standard (AES), or (b) compress the data block using DEFLATE data compression format, the metadata comprising a header sequence of DEFLATE data compression format.

Example 79. An apparatus for secured data decompression, comprising: a data storage means; and a logic means, at least a portion of which is implemented in circuitry coupled to the data storage means, the logic means to: receive a compressed data block generated from a data block using a data-compression technique, the compressed data block having multiple portions, with one portion comprising compressed data and another portion comprising metadata associated with the compressed data, and selective portions of the compressed data block encrypted using an encryption technique, the selective portions comprising at least a portion of the metadata; decrypt the selective portions of the compressed data block; and decompress the compressed data with the aid of the metadata.

Example 80. The apparatus of Example 79, the selective portions comprising at least one selected portion of the compressed data encrypted using the encryption technique.

Example 81. The apparatus of Example 80, a beginning-of-encryption (BOE) token provided at the beginning of the at least one selected portion of the compressed data, an end-of-encryption (EOE) token provided at the end of the at least one selected portion of the compressed data, the logic means to additionally decrypt the at least one selected portion of the compressed data bounded by the BOE token and the EOE token.

What is claimed is:

1. An apparatus, comprising:
a memory; and
logic, at least a portion of which is implemented in circuitry coupled to the memory, the logic to:
receive a data block;
compress the data block using a data-compression technique to generate a compressed data block having multiple portions, with one portion comprising compressed data and another portion comprising metadata associated with the compressed data; and
encrypt selective portions of the compressed data block using an encryption technique, the selective portions comprising at least a portion of the metadata.

2. The apparatus of claim 1, the logic to encrypt at least one selected portion of the compressed data using the encryption technique.

3. The apparatus of claim 2, the logic to:
incorporate a beginning-of-encryption (BOE) token at the beginning of the at least one selected portion of the compressed data; and
incorporate an end-of-encryption (EOE) token at the end of the at least one selected portion of the compressed data.

4. The apparatus of claim 1, the logic to:
incorporate an end-of-block (EOB) token at the end of the compressed data block; and
incorporate an authentication tag after the EOB token.

5. The apparatus of claim 1, the logic to one of:
(a) encrypt at least one selected portion of the compressed data using Advanced Encryption Standard (AES); or
(b) compress the data block using DEFLATE data compression format, the metadata comprising a header sequence of DEFLATE data compression format.

6. The apparatus of claim 1, the logic to compress the data block using Huffman coding, the metadata comprising Huffman codes for interpreting the compressed data.

7. The apparatus of claim 1, the logic comprising at least a portion of a radio frequency (RF) communication device, the logic to transmit the compressed data block.

8. At least one non-transitory machine-readable storage medium comprising instructions that, when executed by a processor element, cause the processor element to:
receive a data block;
compress the data block using a data-compression technique to generate a compressed data block having multiple portions, with one portion comprising compressed data and another portion comprising metadata associated with the compressed data; and
encrypt selective portions of the compressed data block using an encryption technique, the selective portions comprising at least a portion of the metadata.

9. The at least one non-transitory machine-readable storage medium of claim 8, comprising instructions that, when executed by a processor element, cause the processor element to:
encrypt at least one selected portion of the compressed data using the encryption technique

10. The at least one non-transitory machine-readable storage medium of claim 9, comprising instructions that, when executed by a processor element, cause the processor element to:
incorporate a beginning-of-encryption (BOE) token at the beginning of the at least one selected portion of the compressed data; and
incorporate an end-of-encryption (EOE) token at the end of the at least one selected portion of the compressed data.

11. The at least one non-transitory machine-readable storage medium of claim 8, comprising instructions that, when executed by a processor element, cause the processor element to:
incorporate an end-of-block (EOB) token at the end of the compressed data block; and
incorporate an authentication tag after the EOB token.

12. The at least one non-transitory machine-readable storage medium of claim 8, comprising instructions that, when executed by a processor element, cause the processor element to one of:
a) encrypt at least one selected portion of the compressed data using Advanced Encryption Standard (AES); or
b) compress the data block using DEFLATE data compression format, the metadata comprising a header sequence of DEFLATE data compression format.

13. The at least one non-transitory machine-readable storage medium of claim 8, comprising instructions that, when executed by a processor element, cause the processor element to:
compress the data block using Huffman coding, the metadata comprising Huffman codes for interpreting the compressed data.

14. The at least one non-transitory machine-readable storage medium of claim 8, comprising instructions that, when executed by a processor element, cause the processor element to:
transmit the compressed data block to a receiver.

15. An apparatus, comprising:
a memory; and
logic, at least a portion of which is implemented in circuitry coupled to the memory, the logic to:
read a compressed data block generated from a data block using a data-compression technique, the compressed data block having multiple portions, with one portion comprising compressed data and another portion comprising metadata associated with the compressed data, and selective portions of the compressed data block encrypted using an encryption technique, the selective portions comprising at least a portion of the metadata;
decrypt the selective portions of the compressed data block; and
decompress the compressed data with the aid of the metadata.

16. The apparatus of claim 15, the selective portions comprising at least one selected portion of the compressed data encrypted using the encryption technique.

17. The apparatus of claim 16, a beginning-of-encryption (BOE) token provided at the beginning of the at least one selected portion of the compressed data, an end-of-encryption (EOE) token provided at the end of the at least one selected portion of the compressed data, the logic to additionally decrypt the at least one selected portion of the compressed data bounded by the BOE token and the EOE token.

18. The apparatus of claim 15, an end-of-block (EOB) token incorporated at the end of the compressed data block, and a reference authentication tag provided after the EOB token, the logic to compute an authentication tag and compare the computed authentication tag to the reference authentication tag.

19. The apparatus of claim 15, wherein:
(a) at least one selected portion of the compressed data encrypted using Advanced Encryption Standard (AES); or
(b) the data block compressed using DEFLATE data compression format, and the metadata comprising a header sequence of DEFLATE data compression format.

20. The apparatus of claim 15, the data block compressed using Huffman coding, and the metadata comprising Huffman codes for interpreting the compressed data.

21. At least one non-transitory machine-readable storage medium comprising instructions that, when executed by a processor element, cause the processor element to:
read a compressed data block generated from a data block using a data-compression technique, the compressed data block having multiple portions, with one portion comprising compressed data and another portion comprising metadata associated with the compressed data, and selective portions of the compressed data block encrypted using an encryption technique, the selective portions comprising at least a portion of the metadata;
decrypt the selective portions of the compressed data block; and
decompress the compressed data with the aid of the metadata.

22. The at least one non-transitory machine-readable storage medium of claim 21, the selective portions comprising at least one selected portion of the compressed data encrypted using the encryption technique.

23. The at least one non-transitory machine-readable storage medium of claim 22, a beginning-of-encryption (BOE) token provided at the beginning of the at least one selected portion of the compressed data, and an end-of-encryption (EOE) token provided at the end of the at least one selected portion of the compressed data, the at least one non-transitory machine-readable storage medium comprising instructions that, when executed by a processor element, cause the processor element to additionally decrypt the at least one selected portion of the compressed data bounded by the BOE token and the EOE token.

24. The at least one non-transitory machine-readable storage medium of claim 21, an end-of-block (EOB) token incorporated at the end of the compressed data block, and a reference authentication tag provided after the EOB token, the at least one non-transitory machine-readable storage medium comprising instructions that, when executed by a processor element, cause the processor element to compute an authentication tag and compare the computed authentication tag to the reference authentication tag.

25. The at least one non-transitory machine-readable storage medium of claim 21, wherein:
a) at least one selected portion of the compressed data encrypted using Advanced Encryption Standard (AES); or
b) the data block compressed using DEFLATE data compression format, and the metadata comprising a header sequence of DEFLATE data compression format.
